(19) United States
(12) Patent Application Publication
(10) Pub. No.: US 2026/0100021 A1
(43) Pub. Date: Apr. 9, 2026

(54) PROCESSING POINT-CLOUD DATA

(71) Applicant: QUALCOMM Incorporated, San Diego, CA (US)

(72) Inventors: Shubhankar Mangesh BORSE, San Diego, CA (US); Varun RAVI KUMAR, San Diego, CA (US); Senthil Kumar YOGAMANI, San Diego, CA (US)

(21) Appl. No.: 18/905,845

(22) Filed: Oct. 3, 2024

(51) Int. Cl. G06V 10/762; B60W 10/18; B60W 10/20; B60W 30/18; B60W 50/14; G06V 10/774; G06V 20/56

(52) U.S. Cl. CPC G06V 10/762; B60W 10/18; B60W 10/20; B60W 30/18163; G06V 10/774; G06V 20/56; B60W 50/14; B60W 2050/146; B60W 2552/10; B60W 2556/45

(57) ABSTRACT

Systems and techniques are described herein for processing point-cloud data. For instance, a method for processing point-cloud data is provided. The method may include providing numerical values as input to a diffusion model; providing an input point cloud as a conditioning input to the diffusion model; and processing the numerical values using the diffusion model based on the input point cloud to generate an output point cloud, wherein the diffusion model is trained to generate output point clouds based on input point clouds and wherein the output point clouds include more points than are included in the input point clouds.

### TECHNICAL FIELD

The present disclosure generally relates to point-cloud data. For example, aspects of the present disclosure include systems and techniques for processing point-cloud data.

### BACKGROUND

Radio detection and ranging (RADAR) systems and light detection and ranging (LIDAR) systems differ in spatial resolution, range, cost, and complexity to implement.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for processing point-cloud data. According to at least one example, a method is provided for processing point-cloud data. The method includes: providing numerical values as input to a diffusion model; providing an input point cloud as a conditioning input to the diffusion model; and processing the numerical values using the diffusion model based on the input point cloud to generate an output point cloud, wherein the diffusion model is trained to generate output point clouds based on input point clouds and wherein the output point clouds include more points than are included in the input point clouds.

In another example, an apparatus for processing point-cloud data is provided that includes at least one memory and at least one processor (e.g., configured in circuitry) coupled to the at least one memory. The at least one processor configured to: provide numerical values as input to a diffusion model; provide an input point cloud as a conditioning input to the diffusion model; and process the numerical values using the diffusion model based on the input point cloud to generate an output point cloud, wherein the diffusion model is trained to generate output point clouds based on input point clouds and wherein the output point clouds include more points than are included in the input point clouds.

In another example, a non-transitory computer-readable medium is provided that has stored thereon instructions that, when executed by one or more processors, cause the one or more processors to: provide numerical values as input to a diffusion model; provide an input point cloud as a conditioning input to the diffusion model; and process the numerical values using the diffusion model based on the input point cloud to generate an output point cloud, wherein the diffusion model is trained to generate output point clouds based on input point clouds and wherein the output point clouds include more points than are included in the input point clouds.

In another example, an apparatus for processing point-cloud data is provided. The apparatus includes: means for providing numerical values as input to a diffusion model; means for providing an input point cloud as a conditioning input to the diffusion model; and means for processing the numerical values using the diffusion model based on the input point cloud to generate an output point cloud, wherein the diffusion model is trained to generate output point clouds based on input point clouds and wherein the output point clouds include more points than are included in the input point clouds.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram of an example system which may be a portion of an example perception pipeline;

FIG. 2 is a block diagram of an example system which may be a portion of an example perception pipeline;

FIG. 3 is a block diagram of an example system which may be a portion of an example perception pipeline;

FIG. 4 includes a representation of LIDAR point-cloud data and a representation of RADAR point-cloud data;

FIG. 5 is a block diagram illustrating an example system for processing point-cloud data, according to various aspects of the present disclosure;

FIG. 6 is a block diagram of an example system which may be a portion of an example perception pipeline, according to various aspects of the present disclosure;

FIG. 7 is a block diagram illustrating an example system for processing point-cloud data, according to various aspects of the present disclosure;

FIG. 8 includes representations of data processed at various example iterations of a point-cloud-processing process;

FIG. 9 is a block diagram illustrating an example diffusion model or processing point-cloud data, according to various aspects of the present disclosure;

FIG. 10 includes a representation of an example transformer block that may be included in the diffusion model of FIG. 5, the diffusion model of FIG. 7, and/or the diffusion model of FIG. 9, according to various aspects of the present disclosure;

FIG. 11 is a block diagram illustrating an example system that may train diffusion model 1104, according to various aspects of the present disclosure;

FIG. 12 includes representations of data processed at various example iterations of a training process, according to various aspects of the present disclosure;

FIG. 13 includes two sets of images that show the forward diffusion process (which is fixed) and the reverse diffusion process (which is learned) of a diffusion model, according to various aspects of the present disclosure;

FIG. 14 includes a diagram illustrating how diffusion data is distributed from initial data to noise using a diffusion model in the forward diffusion direction, according to various aspects of the present disclosure;

FIG. 15 is a diagram illustrating a U-Net architecture for a diffusion model, according to various aspects of the present disclosure;

FIG. 16 is a flow diagram illustrating an example process for processing point-cloud data, in accordance with aspects of the present disclosure;

FIG. 17 is a block diagram illustrating an example of a deep learning neural network that can be used to perform various tasks, according to some aspects of the disclosed technology;

FIG. 18 is a block diagram illustrating an example of a convolutional neural network (CNN), according to various aspects of the present disclosure; and

FIG. 19 is a block diagram of an example transformer in accordance with some aspects of the disclosure;

FIG. 20 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Radio detection and ranging (RADAR) systems and light detection and ranging (LIDAR) systems differ in spatial resolution, range, cost, and complexity to implement.

Some research efforts have focused on distilling information from LIDAR point-clouds to generate a denser representation of RADAR point-clouds. Despite these efforts, current methods provide single-shot estimates that often result in inaccurate densification of RADAR point-clouds. The limitations of these methods include computational complexity, difficulty in capturing dynamic environments, and challenges in preserving fine-grained details present in RADAR data. Additionally, there are concerns regarding the scalability and real-time performance of these techniques, particularly in scenarios with rapidly changing conditions or high-speed motion. Addressing these issues may be important for advancing the field of RADAR perception. Additionally, addressing these issues may enable robust and reliable autonomous driving systems.

For example, driving systems (e.g., autonomous, semi-autonomous, and/or assisted driving systems, such as an advanced driver assistance systems (ADAS)) of vehicles may assist a driver of a vehicle. Such driving systems may operate at various levels of autonomy. For example, autonomy level 0 requires full control from the driver as the vehicle has no autonomous driving system, and autonomy level 1 involves basic assistance features, such as cruise control, in which case the driver of the vehicle is in full control of the vehicle. Autonomy level 2 refers to semi-autonomous driving, where the vehicle can perform functions, such as drive in a straight path, stay in a particular lane, control the distance from other vehicles in front of the vehicle, or other functions. Autonomy levels 3, 4, and 5 include much more autonomy. For example, autonomy level 3 refers to an on-board autonomous driving system that can take over all driving functions in certain situations, where the driver remains ready to take over at any time if needed. Autonomy level 4 refers to a fully autonomous experience without requiring a user's help, even in complicated driving situations (e.g., on highways and in heavy city traffic). With autonomy level 4, a person may still remain in the driver's seat behind the steering wheel. Vehicles operating at autonomy level 4 can communicate and inform other vehicles about upcoming maneuvers (e.g., a vehicle is changing lanes, making a turn, stopping, etc.). Autonomy level 5 vehicles fully autonomous, self-driving vehicles that operate autonomously in all conditions. A human operator is not needed for the vehicle to take any action.

Driving systems may be perform better with better 3D perception data. For example, driving systems may be better able to perceive objects and/or obstacles when provided with better point-cloud data. Better object detection may allow a driving system to make better (e.g., safer) driving determinations.

Systems, apparatuses, methods (also referred to as processes), and computer-readable media (collectively referred to herein as “systems and techniques”) are described herein for processing point-cloud data. For example, the systems and techniques described herein may leverage a diffusion-model framework and the availability of dense LIDAR data during training to learn how to convert sparser RADAR point clouds into denser, LIDAR-like representations. The dense LIDAR-like representations can then be used for downstream applications such as 3D object detection and/or segmentation. Additionally, the dense LIDAR-like representations can be used by an autonomous, semi-autonomous, or assisted driving system for tasks such as: lane detection, obstacle detection, object tracking, lane-change determination, brake assistance, automated driving, etc. By generating the dense LIDAR-like representations, the systems and techniques may enhance perception capabilities (e.g., of autonomous driving systems). In the present disclosure, the terms “dense” and “denser” and “sparse” and “sparser” may be relative to one another. for example, a first point cloud may be referred to as “dense” or “denser” based on the dense point cloud including more points than a “sparse” or “sparser” point cloud.

The systems and techniques may enable improvements for tasks such as, bird's-eye-view (BEV) segmentation and 3D object detection. The systems and techniques may be used in driving systems, in extended reality (XR) systems (which may include virtual reality (VR) systems, augmented reality (AR) systems, and/or mixed reality (MR) systems), and/or image and/or video capture systems (such as cameras).

Various aspects of the application will be described with respect to the figures below.

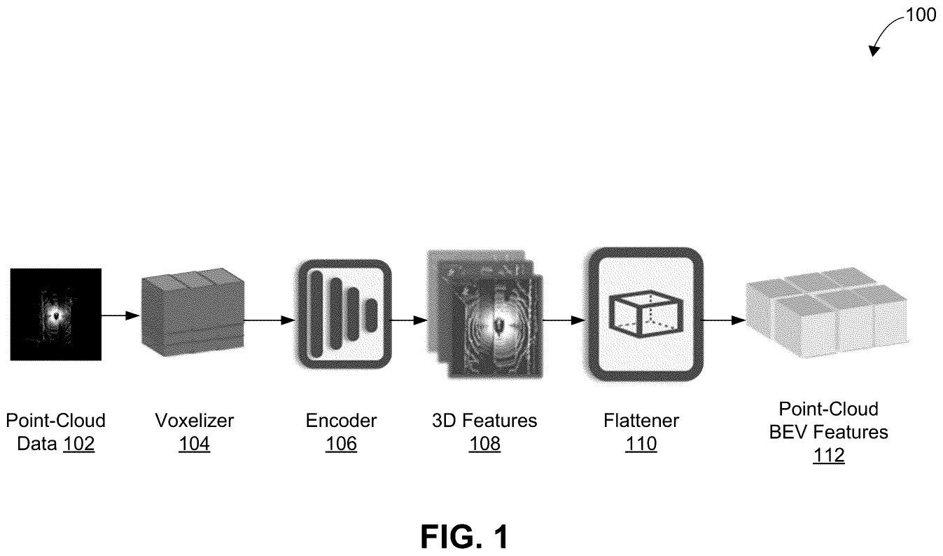

FIG. 1 is a block diagram of an example system 100 which may be a portion of an example perception pipeline. Point-cloud data 102 may be, or may include, 3D-point data, for example, 3D coordinates of points in a 3D space. Point-cloud data 102 may be generated by a RADAR system or a LIDAR system. Voxelizer 104 may spatially downsample point-cloud data 102 to generate voxel data. The voxel data may include indications of whether voxels (e.g., 3D cube shapes in a 3D space) are occupied or unoccupied. Where one or more points of point-cloud data 102 corresponds to a voxel, the voxel may be occupied. Where no points of point-cloud data 102 correspond to a voxel, the voxel may be unoccupied. Encoder 106 may encode the voxel data to generate 3D features 108. Encoder 106 may be, or may include, a perception backbone network, such as a neural network trained to encode voxels as features. Flattener 110 may flatten 3D features 108 into two-dimensions to generate point-cloud bird's-eye-view (BEV) features 112.

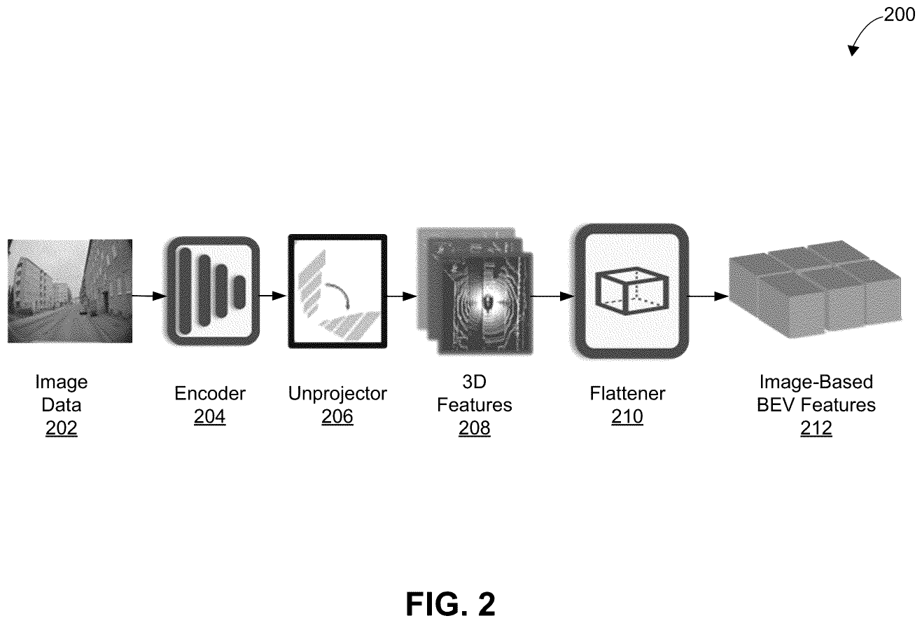

FIG. 2 is a block diagram of an example system 200 which may be a portion of an example perception pipeline. Image data 202 may be, or may include, image data which may be captured by one or more cameras. Encoder 204 may encode image data 202 as image features. Encoder 204 may be, or may include, a camera backbone network, such as a neural network trained to encode image data as features. Unprojector 206 may unproject the 2D image features to generate 3D features 208. Flattener 210 may flatten 3D features 208 into two-dimensions to generate image-based BEV features 212. Image data 202 and the 2D image features generated by encoder 204 may be 2D in the image plane of the camera. In contrast image-based BEV features 212 may be from a BEV perspective.

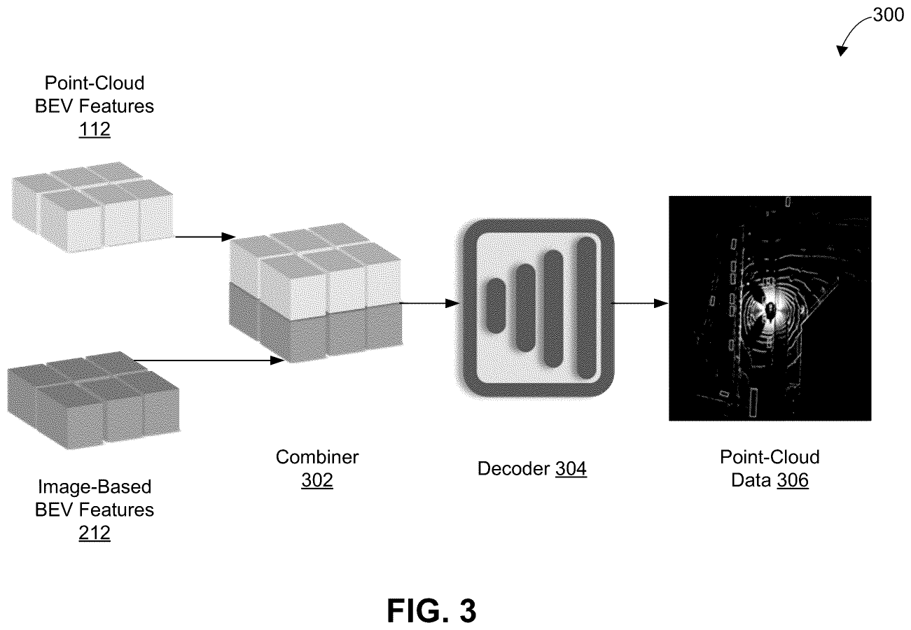

FIG. 3 is a block diagram of an example system 300 which may be a portion of an example perception pipeline. Combiner 302 may combine (e.g., concatenate) point-cloud BEV features 112 with image-based BEV features 212 to generate combined features. Decoder 304 may decode the combined features to generate point-cloud data 306. Point-cloud data 306 may be used, for example, for 3D object detection and/or BEV segmentation.

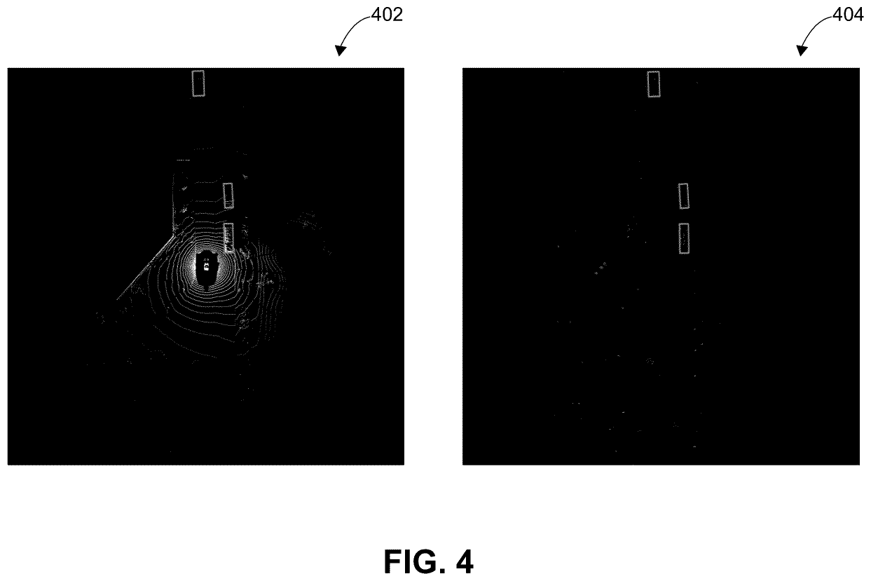

FIG. 4 includes a representation 402 of LIDAR point-cloud data and a representation 404 of RADAR point-cloud data. Representation 402 and representation 404 have been projected into a BEV space to be presented as images. Representation 402 is denser than representation 404. For example, representation 402 includes more data points than representation 404. LIDAR sensors may capture more 3D data points in LIDAR points clouds than RADAR sensors capture in RADAR point clouds.

Downstream tasks, such as 3D object detection and/or BEV segmentation, may perform better using denser point cloud rather than sparser point cloud data. For example, a 3D object detect may be better able to detect 3D objects using the point-cloud data represented by representation 402 than using point-cloud data represented by representation 404. Additionally, downstream tasks related to controlling a vehicle or other system may perform better using denser point clouds as compared with sparser point clouds. For example, an autonomous, semiautonomous, or assisted driving system may perform better in tasks related to steering, braking, accelerating, changing gears, changing lanes, determining a path, etc. based on denser point clouds as compared with sparser point clouds.

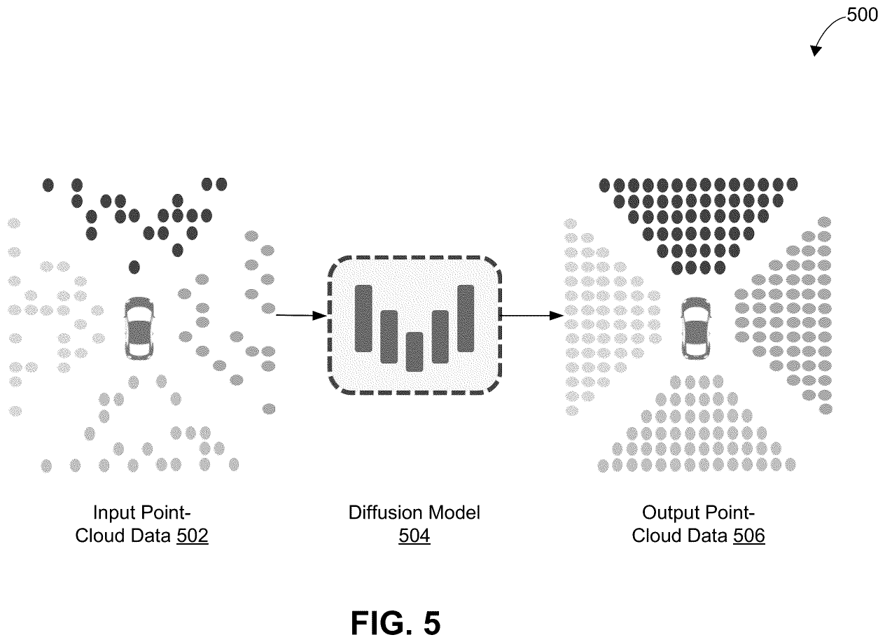

FIG. 5 is a block diagram illustrating an example system 500 for processing point-cloud data, according to various aspects of the present disclosure. In general, diffusion model 504 may process input point-cloud data 502 to generate output point-cloud data 506. Input point-cloud data 502 may be, or may include, sparser point-cloud data, for example, generated by a RADAR system. Diffusion model 504 may be a diffusion-based machine-learning model. Diffusion model 504 may be trained to generate dense point-cloud data based on sparser point-cloud data. Output point-cloud data 506 may be, or may include, dense point-cloud data. Output point-cloud data 506 may be similar to LIDAR point-cloud data. For example, diffusion model 504 may be trained using LIDAR point-cloud data to generate LIDAR-like point-cloud data.

Downstream tasks, such as 3D object detection and/or BEV segmentation, may perform better using output point-cloud data 506 than using input point-cloud data 502. Thus, diffusion model 504 may be used to enrich point-cloud data (e.g., adding points to make enriched point-cloud data more dense than input point-cloud data) which may improve the performance of downstream tasks.

Diffusion model 504 may gradually add noise over multiple iterative steps to input point-cloud data 502. Each step of the diffusion process incrementally increases the density of input point-cloud data 502, making it more similar to dense LIDAR point-cloud data.

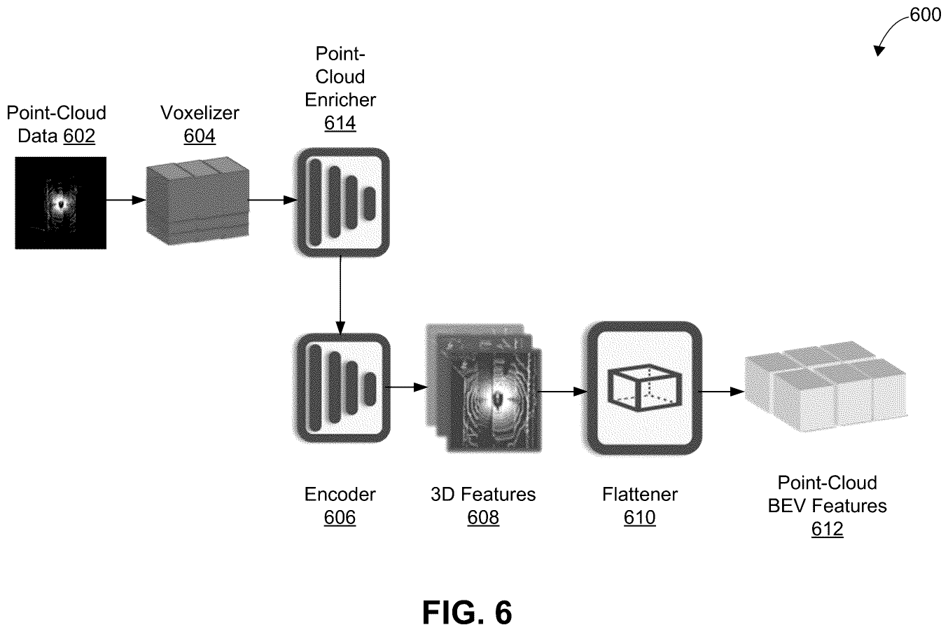

FIG. 6 is a block diagram of an example system 600 which may be a portion of an example perception pipeline, according to various aspects of the present disclosure. System 600 may be similar to system 100 of FIG. 1. For example, point-cloud data 602 may be the same as, or may be substantially similar to, point-cloud data 102. Voxelizer 604 may be the same as, may be substantially similar to, and/or may perform the same, or substantially the same, operations as voxelizer 104.

Point-cloud enricher 614 may be an example of system 500 of FIG. 5. For example, point-cloud enricher 614 may process voxelized point-cloud data from voxelizer 604 to generate enriched point-cloud data. For example, point-cloud enricher 614 may receive sparser point-cloud data from voxelizer 604 and enrich the sparser point-cloud data to generate denser point cloud data.

Encoder 606 may be the same as, may be substantially similar to, and/or may perform the same, or substantially the same, operations as encoder 106. 3D features 608 may be the same as, or may be substantially similar to, 3D features 108. However, where 3D features 108 may represent sparser point-cloud data, 3D features 608 may represent dense point-cloud data as a result of the operation of point-cloud enricher 614. Flattener 610 may be the same as, or may be substantially similar to, flattener 110. Point-cloud BEV features 612 may be the same as, or may be substantially similar to, point-cloud BEV features 112. However, where point-cloud BEV features 112 may represent sparser point-cloud data, point-cloud BEV features 612 may represent dense point-cloud data as a result of the operation of point-cloud enricher 614.

Point-cloud BEV features 612 may, or may not, be combined with features based on image data (e.g., as illustrated and described with regard to FIG. 3. Whether combined with image-based features or not, point-cloud BEV features 612 may be processed by various downstream processing tasks such as 3D object detection and BEV segmentation. The downstream processing tasks may be enabled to produce better results based on point-cloud enricher 614 having enriched point clouds on which point-cloud BEV features 612 are based.

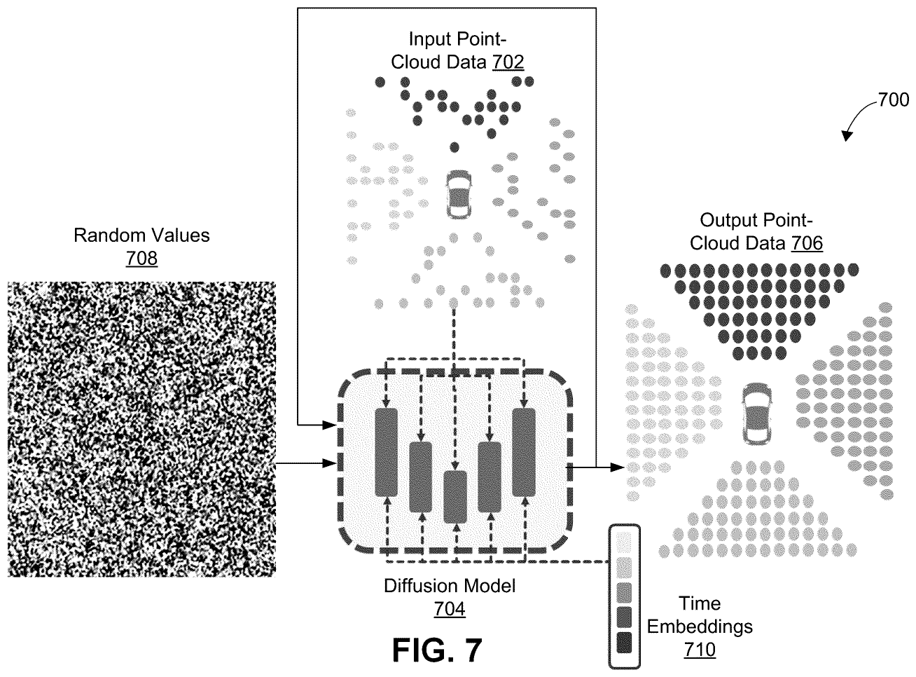

FIG. 7 is a block diagram illustrating an example system 700 for processing point-cloud data, according to various aspects of the present disclosure. In general, diffusion model 704 may process random values 708 as an input and input point-cloud data 702 as a conditioning input to generate output point-cloud data 706.

System 700 may be an example implementation of system 500 of FIG. 5. Input point-cloud data 702 may be the same as, or may be substantially similar to, input point-cloud data 502. Diffusion model 704 may be the same as, may be substantially similar to, and/or may perform the same, or substantially the same, operations as diffusion model 504. Output point-cloud data 706 may be the same as, or may be substantially similar to, output point-cloud data 506.

Random values 708 may be, or may include, a three-dimensional tensor of Gaussian noise values. Random values 708 may be sized based on output point-cloud data 706 and/or input point-cloud data 702. For example, random values 708 may include random values based on a spatial resolution of input point-cloud data 702 and/or a desired spatial resolution of output point-cloud data 706. Time embeddings 710 may be, or may include, values encoding iteration steps for diffusion model 704.

Diffusion model 704 may iteratively process random values 708 based on input point-cloud data 702 to generate output point-cloud data 706. For example, diffusion model 704 may process random values 708 through N iterative processing steps.

During inference, system 700 starts with random values 708 and conditions on the input point-cloud data 702, to iteratively obtain the output point-cloud data 706. Input point-cloud data 702 may be a sparser radar point cloud. System 700 may use input point-cloud data 702 to condition diffusion model 704. Diffusion model 704 applies N recursive denoising steps, starting from random values 708 (which may be, or may include, 3D Gaussian noise) at t=N, to generate a dense, denoised point cloud—output point-cloud data 706, at t=0. System 700 effectively densifies the input point-cloud data 702 to create a LiDAR-like representation—output point-cloud data 706.

In the present disclosure, x_{N} may represent random values 708 initially, before diffusion model 704 has processed random values 708. x_{N-1} may represent the results of processing x_{N} one time. x_{N-1} may be processed to generate x_{N-2}, etc. x₀ may represent output point-cloud data 706, for example, x_{N} after being iteratively processed N times. p_{θ} may represent processing by diffusion model 704. The expression xₜ₋₁=p_{θ}(xₜ) may represent processing xₜ by diffusion model 704.

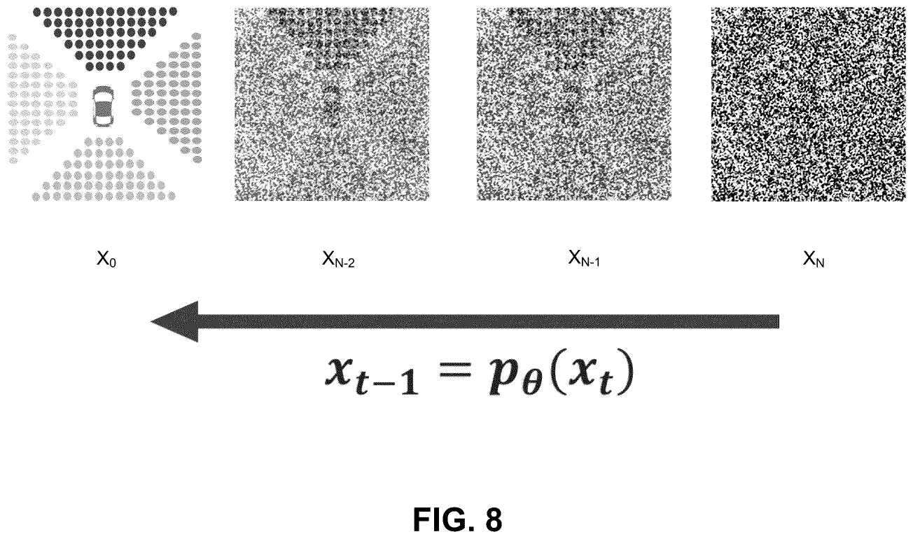

For example, FIG. 8 includes representations of data processed at various example iterations of a point-cloud-processing process. FIG. 8 includes a representation of point cloud data at x_{N}, a representation of point cloud data at x_{N-1}, a representation of point cloud data at x_{N-2}, and a representation of point cloud data at x₀. The representations of FIG. 8 are fabricated for descriptive purposes and are not measured or simulated representations of point clouds.

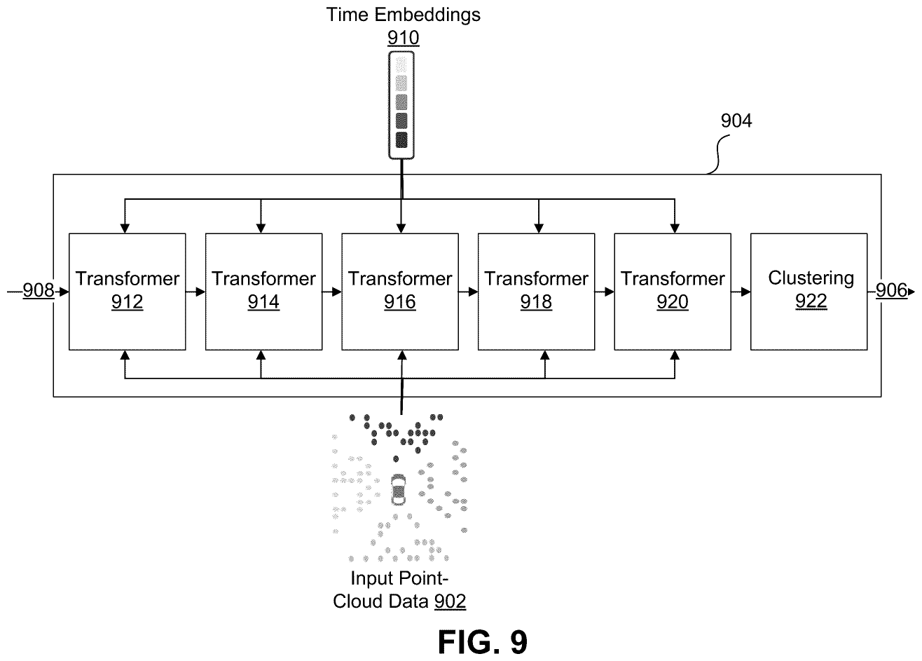

FIG. 9 is a block diagram illustrating an example diffusion model 904 or processing point-cloud data, according to various aspects of the present disclosure. Diffusion model 904 may be an example implementation of diffusion model 504 of FIG. 5 and/or diffusion model 704 of FIG. 7. Input point-cloud data 902 may be the same as, or may be substantially similar to, input point-cloud data 702. Point-cloud data of xₜ₋₁ 906 may represent an output of a given iteration of the iterative diffusion process of system 700. Point-cloud data of xₜ 908 may represent an input of the given iteration of the iterative diffusion process of system 700. Time embeddings 910 may be the same as, or may be substantially similar to, time embeddings 710.

Diffusion model 904 includes five transformers (e.g., transformer block 912, transformer block 914, transformer block 916, transformer block 918, and transformer block 920) as examples. Diffusion model 904 may include any number of transformer blocks.

In some aspects, diffusion model 904 includes clustering block 922. Clustering block 922 may cluster 3D points of point-cloud data. Clustering block 922 may operate on data later in the iterative process. For example, in some aspects, clustering block 922 may operate on a data after a final step of the iterative process.

Clustering block 922 performs soft clustering of the point cloud features. Clustering block 922 may cluster 3D data points into clusters and output a single point representative of a cluster rather than the entire cluster. Clustering can reduce the size of point clouds while keeping the relevant data (e.g., by not providing points that are so spatially close that they are redundant). Additionally, clustering may reduce hallucinated data points that may be generated by diffusion model 904.

Clustering block 922 may cluster points according to one or more clustering approaches including, intra-frame clustering, inter-frame clustering, and foreground-background clustering. In intra-frame clustering, clustering block 922 may identify clusters of 3D data points from a one point-cloud capture at one time. Clustering block 922 may identify clusters based on a spatial distance, for example, according to a Cosine similarity between points of a cluster.

For example, intra-point clustering may distill a pseudo-LiDAR embedding affinity matrix A_{i,j} to the assignment probability affinity matrix δ_{i, j}, based on the cosine similarity between the content-aware embeddings of a single point cloud. The assignment probability matrix can be defined as the probability of an embedding Pᵢ assigned to a group Zᵢ. To prevent dominant groups and ensure balanced assignments, an entropy regularization is added. This also maintains a reasonable average voxel embedding probability per group token. Self-distillation loss is used to constrain the assignment probability of patches to groups Z, based on the affinity matrix δ_{i,j}. Since, the distillation is unsupervised and class-agnostic, the loss is computed for each point cloud.

In inter-frame clustering, clustering block 922 may cluster points based on an input point cloud with points based on a prior input point cloud. For example, clustering block 922 may store an output point cloud based on a prior input point cloud and compare a current point cloud with the prior output point cloud.

For example, to harmonize groups across point clouds and capture contextual object relationships, an inter-frame clustering supervision is added to the group assignment. Inter-frame clustering enriches understanding of object boundaries and enhances grouping accuracy. Given the voxel embedding affinity matrix A_{i,j}, for all point clouds in the batch, inter-frame clustering performs spectral clustering to group similar regions together. The graph CNN is then updated to maximize the assignment probability affinity matrix δ_{i,j} for similar groups across batches. This causes similar objects from different frames to be grouped together.

In foreground-background clustering, to cause foreground and background voxels to have similar embeddings, content-aware embeddings are fed through a sigmoid layer to group the embeddings in two groups. The cosine similarity between the pseudo-LiDAR embeddings across the point clouds is used to extract the foreground and background voxel groups. To push the two embedding for foreground and background points/features apart, a negative contrastive loss is used.

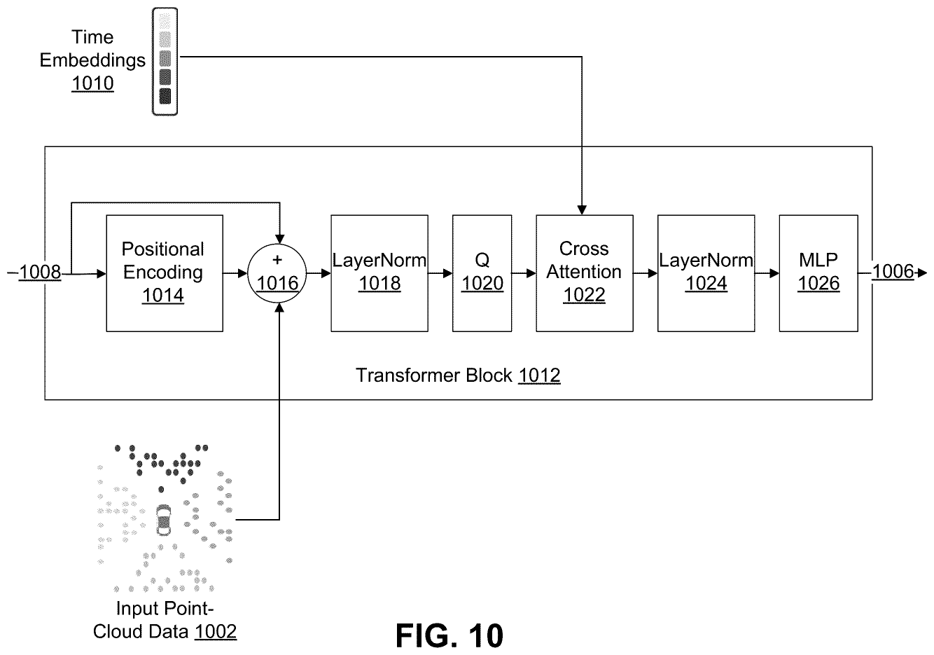

FIG. 10 includes a representation of an example transformer block 1012 that may be included in diffusion model 504 of FIG. 5, diffusion model 704 of FIG. 7, and/or diffusion model 904 of FIG. 9, according to various aspects of the present disclosure. For example, transformer block 1012 may be an example of any or all of transformer block 912, transformer block 914, transformer block 916, transformer block 918, and/or transformer block 920 of FIG. 9. Diffusion model 504, diffusion model 704, and/or positional encoding block 1014 may include several (e.g., M) instances of transformer block 1012.

Input point-cloud data 1002 may be the same as, or may be substantially similar to, input point-cloud data 502, input point-cloud data 702, and/or input point-cloud data 902. Point-cloud data of xₜ₋₁ 1006 may be an output of transformer block 1012 for a given iteration of the diffusion process of system 500 or system 700. Diffusion model 504 and/or diffusion model 704 may include multiple instances of transformer block 1012, so point-cloud data of xₜ₋₁ 1006 may, or may not, be an output of the final transformer block of diffusion model 504 and/or diffusion model 704 (e.g., the final output of the given iteration of the diffusion process). Nevertheless, for descriptive purposes, point-cloud data of xₜ₋₁ 1006 is referred to as point-cloud data of xₜ₋₁ 1006. Similarly, point-cloud data of xₜ 1008 may be an input of transformer block 1012 for the given iteration of the diffusion process of system 500 and/or system 700. Transformer block 1012 may, or may not, be the first transformer block of diffusion model 504 and/or diffusion model 704, so point-cloud data of xₜ 1008 may, or may not, be the input of the first transformer block of diffusion model 504 and/or diffusion model 704 (e.g., the first input of the given iteration of the diffusion process). Nevertheless, for descriptive purposes, point-cloud data of xₜ 1008 is referred to as point-cloud data of xₜ 1008. Time embeddings 1010 may be the same as, or may be substantially similar to, time embeddings 710.

Time embeddings 1010 are fed into cross attention block 1022 to capture the temporal information of the diffusion process. Combiner 1016 may combine (e.g., concatenate) point-cloud data of xₜ 1008 with the encoded instance of point-cloud data of xₜ 1008 output by positional encoding block 1014 and with input point-cloud data 1002. LayerNorm block 1018 performs normalization on the input point cloud features. Query block 1020 computes query vectors for the attention mechanism. Cross attention block 1022 performs cross-attention between the input point cloud and the pseudo-LiDAR embeddings. LayerNorm block 1024 performs another normalization. Multi-layer perceptron (MLP) block 1026 processes the features.

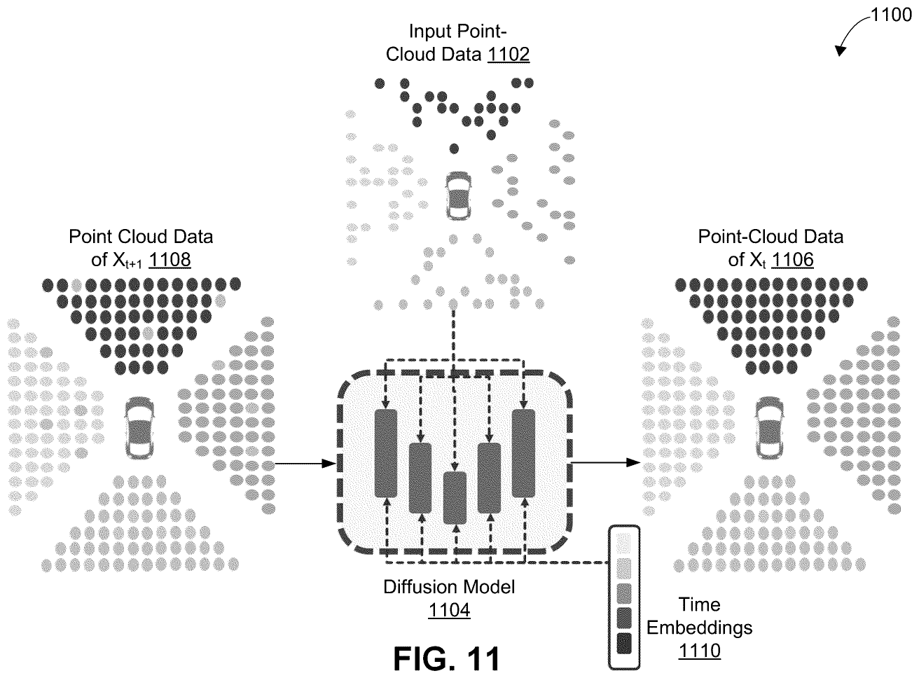

FIG. 11 is a block diagram illustrating an example system 1100 that may train diffusion model 1104, according to various aspects of the present disclosure. In general, system 1100 may condition diffusion model 1104 on input point-cloud data 1102 (which may be sparser LIDAR point-cloud data) during the training of diffusion model 1104. System 1100 may train diffusion model 504 of FIG. 5, point-cloud enricher 614 of FIG. 6, diffusion model 704 of FIG. 7, and/or diffusion model 904 of FIG. 9. Additionally or alternatively, diffusion model 504 of FIG. 5, point-cloud enricher 614 of FIG. 6, diffusion model 704 of FIG. 7, and/or diffusion model 904 of FIG. 9 may be trained according to the principles described with regard to system 1100.

System 1100 may be, or may include, a diffusion scheduler. For example, system 1100 may store point cloud data x at various steps of the diffusion process (e.g., various t).

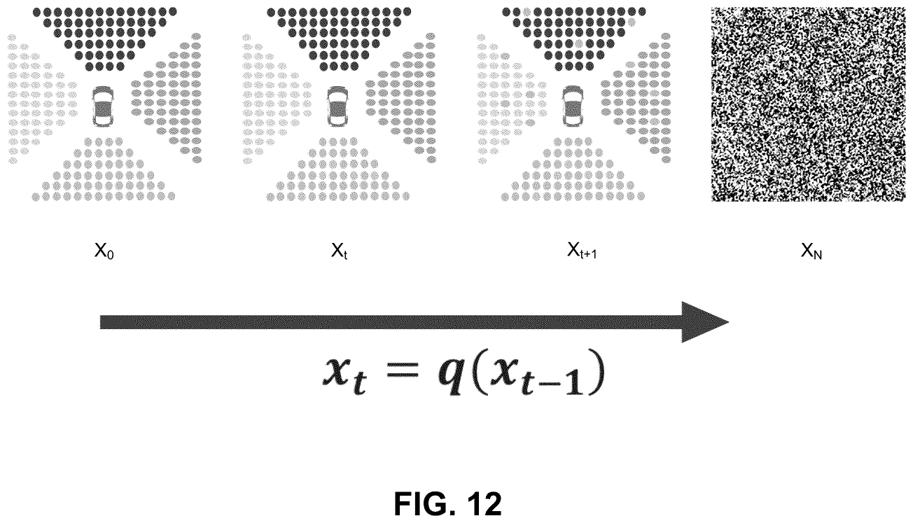

For example, FIG. 12 includes representations of data processed at various example iterations of a training process, according to various aspects of the present disclosure. FIG. 12 includes a representation of point cloud data at x₀, a representation of point cloud data at xt, a representation of point cloud data at xₜ₊₁, and a representation of point cloud data at x_{N}. The representations of FIG. 12 are fabricated for descriptive purposes and are not measured or simulated representations of point clouds.

Returning to FIG. 11, system 1100 may train diffusion model 1104 using a reverse diffusion process. For example, system 1100 may iteratively add random values (e.g., noise) to an input point cloud. For example, given an input point cloud xₜ₋₁ for a given time step t, diffusion model 1104 may generate xₜ by adding noise to xₜ₋₁. The expression xt=q(xₜ₋₁) may represent one step of the iterative process. System 1100 may train diffusion model 1104 to denoise point clouds. For example, for a given iterative step, system 1100 may train diffusion model 1104 to generate xₜ based on xₜ₋₁. Further, system 1100 may train diffusion model 1104 to denoise the point clouds based on a conditioning input. For example, system 1100 may train diffusion model 1104 to generate point-cloud data of xₜ 1106 based on point cloud data of xₜ₊₁ 1108 and input point-cloud data 1102.

Input point-cloud data 1102 may be, or may include, a randomly subsampled dense point cloud (e.g., a LIDAR point cloud). For example, input point-cloud data 1102 may be randomly subsampled to a certain percentage (K %) of its original density. As such, input point-cloud data 1102 may simulate the sparsity of radar data and provides a noisy input for the reverse diffusion process.

During training, diffusion model 1104 may learn to reverse the noising process by using a dense point cloud (e.g., a LIDAR point cloud) as the target. The training follows a deterministic point sampling process. The training process may start with the dense point cloud at t=0. At each step t, the training process may include sampling a subset of points from the previous noisy point cloud xₜ₋₁ to form xₜ. The training process may include adding Gaussian noise at the final step t=N to create the initial noisy point cloud

$${x}_{N}^{( N )} .$$

During training, diffusion model 1104 learns to reverse the noise addition process by using a dense point cloud (e.g., a LIDAR point cloud) as the target. The reverse diffusion process involves taking the noisy pseudo-LIDAR point cloud xₜ as input and learning to denoise it using the conditioning information (input point-cloud data 1102) through N recursive steps of a denoising model p_{θ}.

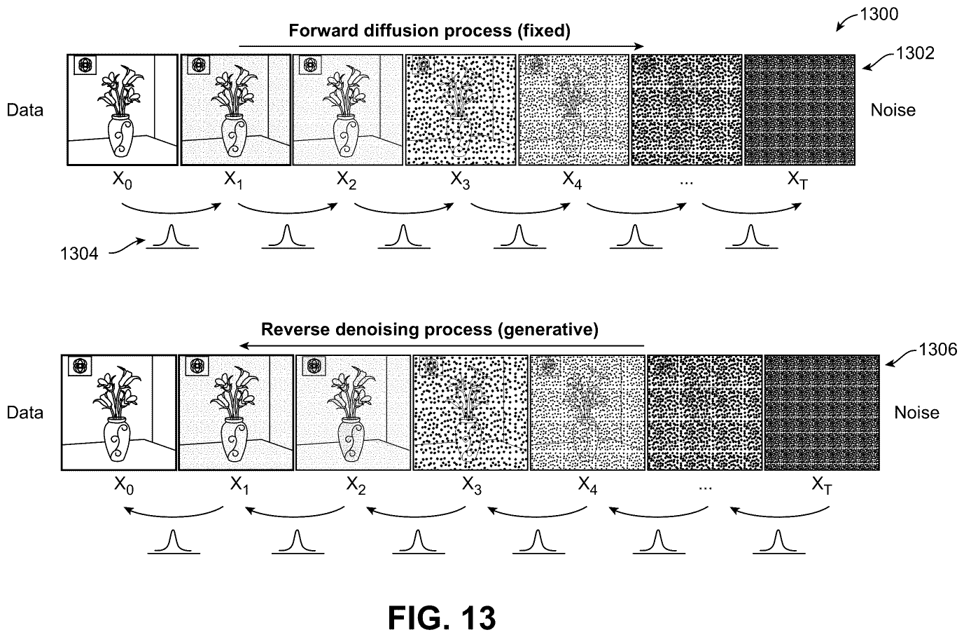

FIG. 13 includes two sets of images 1300 that show the forward diffusion process (which is fixed) and the reverse diffusion process (which is learned) of a diffusion model, according to various aspects of the present disclosure. As shown in the forward diffusion process of FIG. 13, noise 1304 is gradually added to a first set of images 1302 at different time steps for a total of T time steps (e.g., making up a Markov chain), producing a sequence of noisy samples X₁ through X_{T}.

Diffusion models from a training perspective will take an image and will slowly add noise to the image to obscure the information in the image. In some aspects, the noise 1304 is Gaussian noise. Each time step can correspond to each consecutive image of the first set of images 1302 shown in FIG. 13. The initial image X₀ of FIG. 13 is of a vase of flowers. Addition of the noise 1304 to each image (corresponding to noisy samples X₁ to X_{T}) results in gradual diffusion of the pixels in each image until the final image (corresponding to sample X_{T}) essentially matches the noise distribution. For example, by adding the noise, each data sample X₁ through X_{T} gradually loses its distinguishable features as the time step becomes larger, eventually resulting in the final sample X_{T} being equivalent to the target noise distribution, for instance a unit variance zero-Gaussian [symbol] (0,1).

The second set of images 1306 shows the reverse diffusion process in which X_{T} is the starting point with a noisy image (e.g., one that has Gaussian noise). The diffusion model can be trained to reverse the diffusion process (e.g., by training a model p_{θ}(xₜ₋₁|xₜ)) to generate new data. In some aspects, a diffusion model can be trained by finding the reverse Markov transitions that maximize the likelihood of the training data. By traversing backwards along the chain of time steps, the diffusion model can generate the new data. For example, as shown in FIG. 13, the reverse diffusion process proceeds to generate X₀ as the image of the vase of flowers. In other cases, the input data and output data can vary based on the task for which the diffusion model is trained.

As noted above, the diffusion model is trained to be able to denoise or recover the original image X₀ in an incremental process as shown in the second set of images 1306. In some aspects, the neural network of the diffusion model can be trained to recover Xₜ given Xₜ₋₁, such as provided in the below example equation:

$$q ( {x}_{t} \vert {x}_{t - 1} ) = 𝒩 ( {x}_{t} ; \sqrt{1 - {β}_{t}} {x}_{t - 1} , {β}_{t} I )$$

A diffusion kernel can be defined as:

$$Define {\hat{∝}}_{t} = {\prod }_{s = 1}^{t} ( 1 - {β}_{s} ) \to q ( {x}_{t} \vert {x}_{0} ) = 𝒩 ( {x}_{t} ; \sqrt{{\hat{∝}}_{t}} {x}_{0} , ( 1 - {\hat{∝}}_{t} ) I )$$

Sampling can be defined as follows:

$${x}_{t} = \sqrt{{\hat{∝}}_{t}} {x}_{0} + \sqrt{1 - {\hat{∝}}_{t}} ε where ε ∼ 𝒩 ( 0 , I ) .$$

In some cases, the βₜ values schedule (also referred to as a noise schedule) is designed such that \hat{α}_{T}→0 and q(x_{T}|x₀)≈ [symbol] (x_{T}; 0, I).

The diffusion model runs in an iterative manner to incrementally generate the input image X₀. In one example, the model may have twenty steps. However, in other examples, the number of steps can vary.

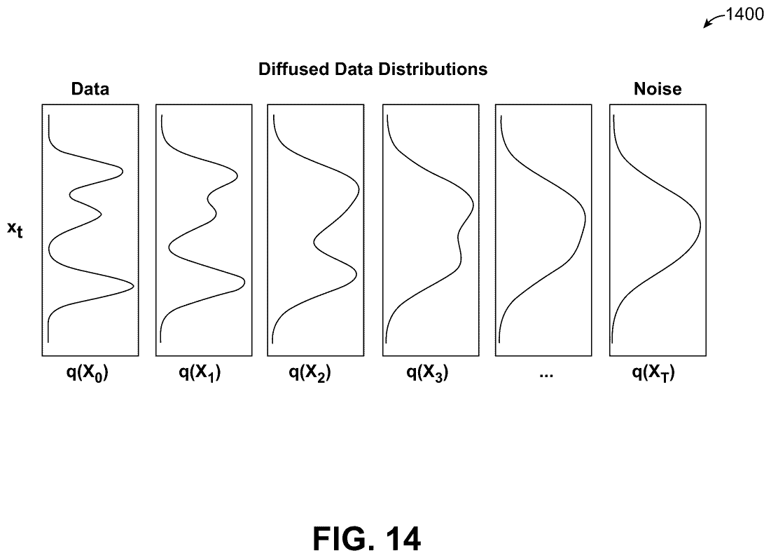

FIG. 14 includes a diagram 1400 illustrating how diffusion data is distributed from initial data to noise using a diffusion model in the forward diffusion direction, according to various aspects of the present disclosure. Note that the initial data q(X₀) is detailed in the initial stage of the diffusion process. An illustrative example of the data q(X₀) is the initial image of the flowers in a vase shown in FIG. 13. As the diffusion model iterates and iteratively adds sampled noise to the data from t=0 to t=T, as shown in FIG. 14, the data becomes nosier and may ultimately result in pure noise (e.g., at q(X_{T})). The example of FIG. 14 illustrates the progression of the data and how it becomes diffused with noise in the forward diffusion process.

In some aspects, the diffused data distribution (e.g., as shown in FIG. 14) can be as follows:

$$q ( {x}_{t} ) = \int q ( {x}_{0} , {x}_{t} ) {dx}_{0} = \int q ( {x}_{0} ) q ( {x}_{t} \vert {x}_{0} ) {dx}_{0} .$$

In the above equation, q(xₜ) represents the diffused data distribution, q(x₀,xₜ) represents the joint distribution, q(x₀) represents the input data distribution, and q(xₜ|x₀) is the diffusion kernel. In this regard, the model can sample xₜ˜q(xₜ) by first sampling x₀˜q(x₀) and then sampling xₜ˜q(xₜ|x₀) (which may be referred to as ancestral sampling). The diffusion kernel takes the input and returns a vector or other data structure as output.

The following is a summary of a training algorithm and a sampling algorithm for a diffusion model. A training algorithm can include the following steps:

1: repeat
2: x₀ ~ q(x₀)
3: t ~ Uniform ({1,...,T })
4: ∈ ~ [symbol] (0, I)
5: Take gradient descent step on
∇_{Ø} || ∈ − ∈_{Ø} (\sqrt{\hat{α}ₜ x₀}+ \sqrt{1 − \hat{α}ₜ}∈, t) ||²
6: until converged

A sampling algorithm can include the following steps:

1: x_{T} ~ [symbol] (0, I)
2: for t = T, ... , 1 do
3: z ~ [symbol] (0, I)
$4 : {x}_{t - 1} = \frac{1}{\sqrt{{\hat{α}}_{t}}} ( {x}_{t} - \frac{1 - {\hat{α}}_{t}}{\sqrt{1 - {\hat{α}}_{t}}} {∈}_{∅} ( {x}_{t} , t ) ) + {σ}_{t} z$
5: end for
6: return x₀

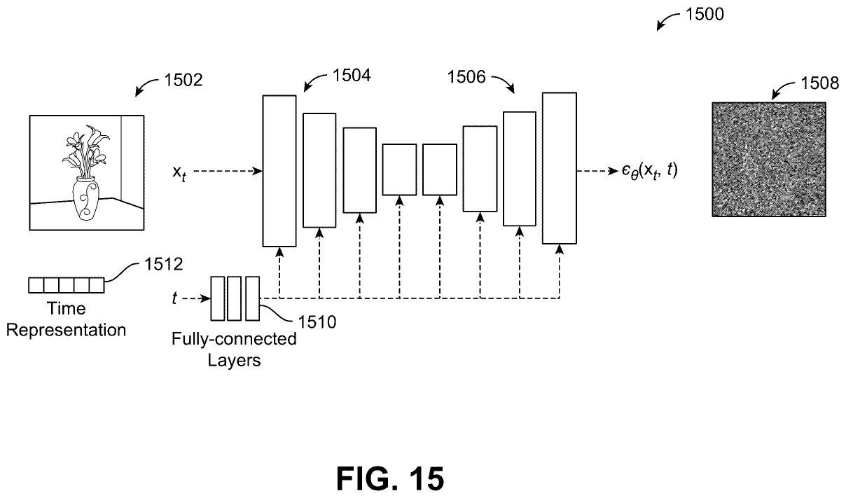

FIG. 15 includes a diagram illustrating a U-Net architecture 1500 for a diffusion model, according to various aspects of the present disclosure. The initial image 1502 (e.g., a vase of flowers) is provided to the U-Net architecture 1500 which includes a series of residual networks (ResNet) blocks and self-attention layers to represent the network ϵ_{Θ} (xₜ, t). The U-Net architecture 1500 also includes fully-connected layers 1510. In some cases, time representation 1512 can be sinusoidal positional embeddings or random Fourier features. Noisy output 1508 from the forward diffusion process is also shown.

The U-Net architecture 1500 includes a contracting path 1504 and an expanding path 1506 as shown in FIG. 15, which gives it the U-shaped architecture. The contracting path 1504 can be a convolutional network that includes repeated convolutional layers (that apply convolutional operations), each followed by a rectified linear unit (ReLU) and a max pooling operation. When images are being processed (e.g., the image 1502) during the contracting path 1504, the spatial information of the image 1502 is reduced as features are generated. The expanding path 1506 combines the features and spatial information through a sequence of up-convolutions and concatenations with high-resolution features from the contracting path 1504. Some of the layers can be self-attention layers, which leverage global interactions between semantic features at the end of the encoder to explicitly model full contextual information.

Latent diffusion models (also referred to as stable diffusion models) introduce a diffusion process in the latent space of a machine learning model (e.g., variational autoencoder (VAE) neural network), making the machine learning model more efficient while enabling high-resolution image synthesis. For example, an Encoder ( [symbol] )-Decoder (D) pair of a VAE can be trained to capture a low-dimensional latent distribution given by z= [symbol] (x) such that x≈D(z). The denoising process outlined above can be formulated in this latent space by training a U-Net (e.g., U-Net architecture 1500 of FIG. 15), which may include ResNet blocks and attention modules in some cases, to predict the noise introduced in the forward diffusion process, which optimizes the objective given by the following:

$${min}_{θ} {𝔼}_{z 0 , ϵ ∼ N ( 0 , 1 ) , t ∼ U ( 0 , T )} {‖ ϵ - {ϵ}_{θ} ( {z}_{t} , t , c ) ‖}_{2}^{2}$$

Here, ϵ is the total noise introduced to the noise-free latent z₀˜E(x) by the scheduler in T steps, zₜ is the corresponding partially-noisy latent at diffusion timestep t, and c is conditioning (e.g., text prompt embedding provided as input). With the predicted noise ϵ_{θ}, denoising diffusion implicit models (DDIM) sampling can be applied on z_{T} over T steps iteratively to recover z₀ in the original latent data distribution, such as in the following:

$${z}_{t - 1} = \sqrt{{α}_{t - 1}} \frac{{z}_{t} - \sqrt{1 - {α}_{t} {ϵ}_{θ}}}{\sqrt{{α}_{t}}} + \sqrt{1 - {α}_{t} {ϵ}_{θ}} ,$$

where αₜ is a parameter for noise scheduler.

When adopting Stable Diffusion (SD) to video generation or video editing, a key factor is to ensure the temporal consistency of a generated frame relative to one or more previous frames in the video. In addition to modifications to the U-Net model (such as temporal attention and 2+1D convolutions), it helps to rely on control signals, and/or DDIM inversion to start the denoising with a correlated set of noise latents.

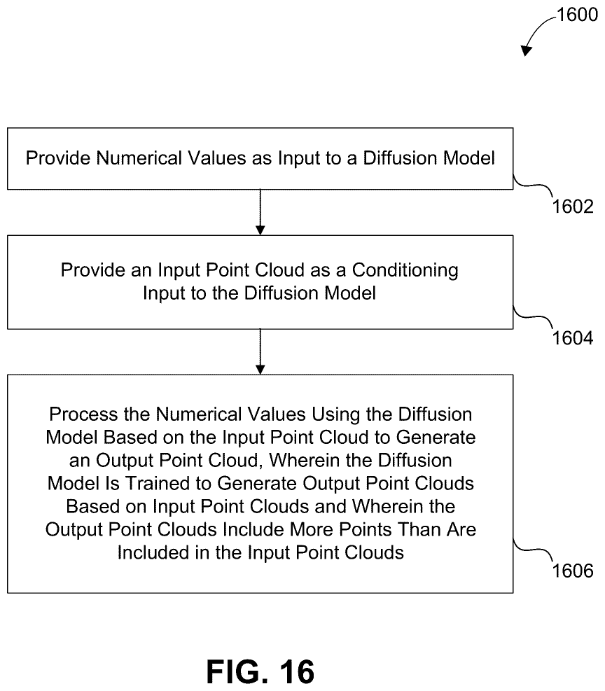

FIG. 16 is a flow diagram illustrating an example process 1600 for processing point-cloud data, in accordance with aspects of the present disclosure. One or more operations of process 1600 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1600. The one or more operations of process 1600 may be implemented as software components that are executed and run on one or more processors.

At block 1602, a computing device (or one or more components thereof) may provide numerical values as input to a diffusion model. For example, system 700 may provide random values 708 to diffusion model 704 as an input.

In some aspects, the numerical values comprise a tensor of gaussian random values. For example, random values 708 may be, or may include, a tensor of gaussian random values.

In some aspects, the numerical values comprise random values. For example, random values 708 may be, or may include, random values.

At block 1604, the computing device (or one or more components thereof) may provide an input point cloud as a conditioning input to the diffusion model. For example, system 700 may provide input point-cloud data 702 to diffusion model 704 as a conditioning input.

At block 1606, the computing device (or one or more components thereof) may process the numerical values using the diffusion model based on the input point cloud to generate an output point cloud, wherein the diffusion model is trained to generate output point clouds based on input point clouds and wherein the output point clouds include more points than are included in the input point clouds. For example, system 700 may process random values 708 using diffusion model 704 based on input point-cloud data 702 to generate output point-cloud data 706. Diffusion model 704 may be trained to process input point clouds to generate output point clouds that have more data points than the input point clouds.

In some aspects, the diffusion model may be trained using training random values as input and training point clouds as conditioning inputs. For example, diffusion model 704 may be trained to using random values as input and training point clouds as conditioning input, for instance as described with regard to FIG. 11.

In some aspects, the training point clouds may be generated by a light detection and ranging (LIDAR) system. The input point cloud provided at block 1606 may be, or may include, a point cloud generated by a radio detection and ranging (RADAR) system.

In some aspects, the training point clouds may be downsampled prior to being used to train the diffusion model. For example, the training point clouds may be downsampled prior to being used as conditioning inputs, for instance as described with regard to FIG. 11.

In some aspects, the computing device (or one or more components thereof) may provide time embeddings as keys and values to a cross-attention layer of the diffusion model. For example, transformer block 1012 may provide time embeddings 1010 to cross attention block 1022 as keys and values.

In some aspects, the computing device (or one or more components thereof) may cluster points of the output point cloud. For example, clustering block 922 may cluster points.

In some aspects, the points may be clustered based on a spatial distance within the output point cloud. For example, clustering block 922 may cluster points of a point cloud based on a special distance between points of the point cloud, for instance, according to a Cosine similarity between points of a cluster.

In some aspects, the points may be clustered based on entropy. For example, clustering block 922 may cluster points according to entropy. To prevent dominant groups and ensure balanced assignments, an entropy regularization is added. This also maintains a reasonable average voxel embedding probability per group token. Self-distillation loss is used to constrain the assignment probability of patches to groups Z, based on the affinity matrix δ_{i,j}. Since, the distillation is unsupervised and class-agnostic, the loss is computed for each point cloud.

In some aspects, the points may be clustered based on another point cloud. For example, clustering block 922 may store an output point cloud based on a prior input point cloud and compare a current point cloud with the prior output point cloud.

In some aspects, the computing device (or one or more components thereof) may be, or may be included in, a computing system of a vehicle.

In some aspects, the computing device (or one or more components thereof) may adjust an operating parameter of the vehicle based on the output point cloud.

In some aspects, the operating parameter nay be associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the output point cloud using a user interface of the vehicle

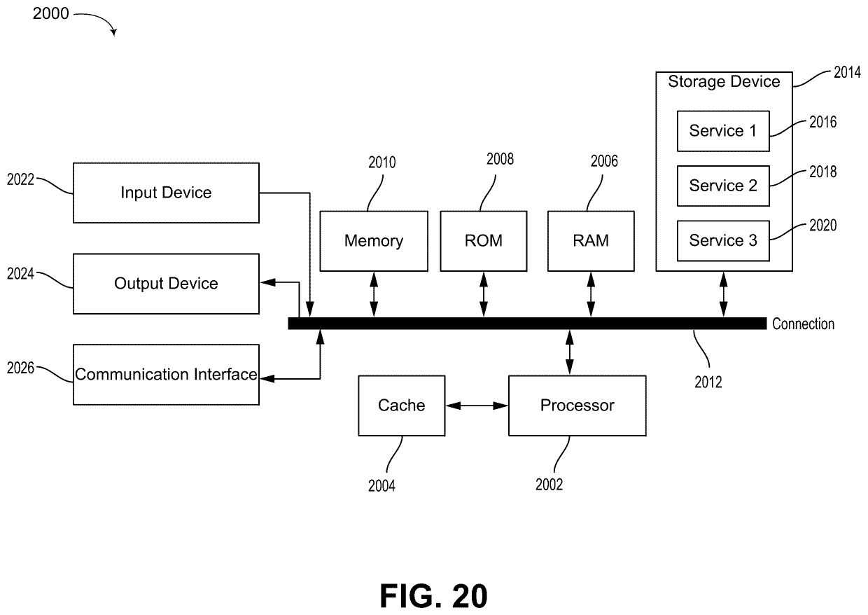

In some examples, as noted previously, the methods described herein (e.g., process 1600 of FIG. 16, and/or other methods described herein) can be performed, in whole or in part, by a computing device or apparatus. In one example, one or more of the methods can be performed by system 500 of FIG. 5, system 600 of FIG. 6, system 700 of FIG. 7, or by another system or device. In another example, one or more of the methods (e.g., process 1600, and/or other methods described herein) can be performed, in whole or in part, by the computing-device architecture 2000 shown in FIG. 20. For instance, a computing device with the computing-device architecture 2000 shown in FIG. 20 can include, or be included in, the components of the system 500, system 600, and/or system 700 and can implement the operations of process 1600, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1600, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1600, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

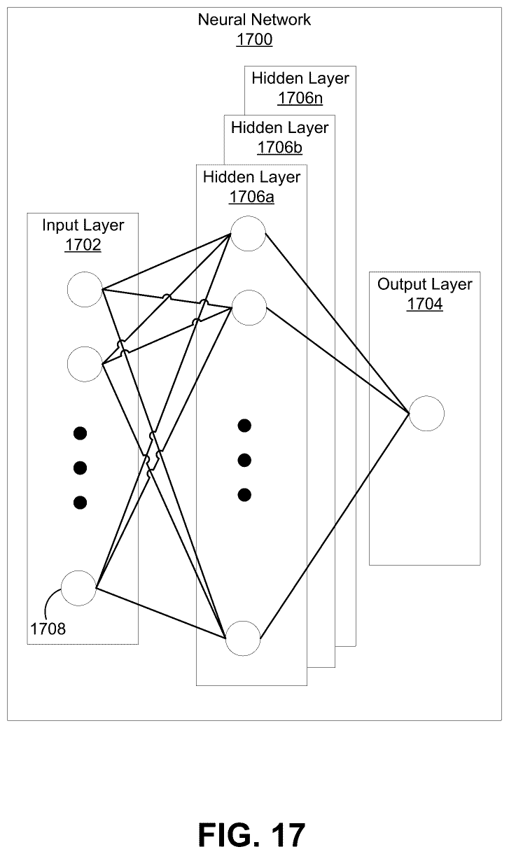

FIG. 17 is an illustrative example of a neural network 1700 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1700 may be an example of, or can implement, encoder 106 of FIG. 1, encoder 204 of FIG. 2, decoder 304 of FIG. 3, encoder 606 of FIG. 6, MLP block 1026 of FIG. 10, contracting path 1504 of FIG. 15, and/or expanding path 1506 of FIG. 15.

An input layer 1702 includes input data. In one illustrative example, input layer 1702 can include data representing image data 202 of FIG. 2. Neural network 1700 includes multiple hidden layers, for example, hidden layers 1706a, 1706b, through 1706n. The hidden layers 1706a, 1706b, through hidden layer 1706n include “n” number of hidden layers, where “n” is an integer greater than or equal to one. The number of hidden layers can be made to include as many layers as needed for the given application. Neural network 1700 further includes an output layer 1704 that provides an output resulting from the processing performed by the hidden layers 1706a, 1706b, through 1706n. In one illustrative example, output layer 1704 can generate 3D features 108 of FIG. 1, point-cloud data 306 of FIG. 3, and/or 3D features 608 of FIG. 6.

Neural network 1700 may be, or may include, a multi-layer neural network of interconnected nodes. Each node can represent a piece of information. Information associated with the nodes is shared among the different layers and each layer retains information as information is processed. In some cases, neural network 1700 can include a feed-forward network, in which case there are no feedback connections where outputs of the network are fed back into itself. In some cases, neural network 1700 can include a recurrent neural network, which can have loops that allow information to be carried across nodes while reading in input.

Information can be exchanged between nodes through node-to-node interconnections between the various layers. Nodes of input layer 1702 can activate a set of nodes in the first hidden layer 1706a. For example, as shown, each of the input nodes of input layer 1702 is connected to each of the nodes of the first hidden layer 1706a. The nodes of first hidden layer 1706a can transform the information of each input node by applying activation functions to the input node information. The information derived from the transformation can then be passed to and can activate the nodes of the next hidden layer 1706b, which can perform their own designated functions. Example functions include convolutional, up-sampling, data transformation, and/or any other suitable functions. The output of the hidden layer 1706b can then activate nodes of the next hidden layer, and so on. The output of the last hidden layer 1706n can activate one or more nodes of the output layer 1704, at which an output is provided. In some cases, while nodes (e.g., node 1708) in neural network 1700 are shown as having multiple output lines, a node has a single output and all lines shown as being output from a node represent the same output value.

In some cases, each node or interconnection between nodes can have a weight that is a set of parameters derived from the training of neural network 1700. Once neural network 1700 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1700 to be adaptive to inputs and able to learn as more and more data is processed.

Neural network 1700 may be pre-trained to process the features from the data in the input layer 1702 using the different hidden layers 1706a, 1706b, through 1706n in order to provide the output through the output layer 1704. In an example in which neural network 1700 is used to identify features in images, neural network 1700 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1700 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1700 is trained well enough so that the weights of the layers are accurately tuned.

For the example of identifying objects in images, the forward pass can include passing a training image through neural network 1700. The weights are initially randomized before neural network 1700 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1700, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1700 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½ (target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1700 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and f denotes a learning rate. The learning rate can be set to any suitable value, with a high learning rate including larger weight updates and a lower value indicating smaller weight updates.

Neural network 1700 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1700 can include any other deep network other than a CNN, such as an autoencoder, a deep belief nets (DBNs), a Recurrent Neural Networks (RNNs), among others.

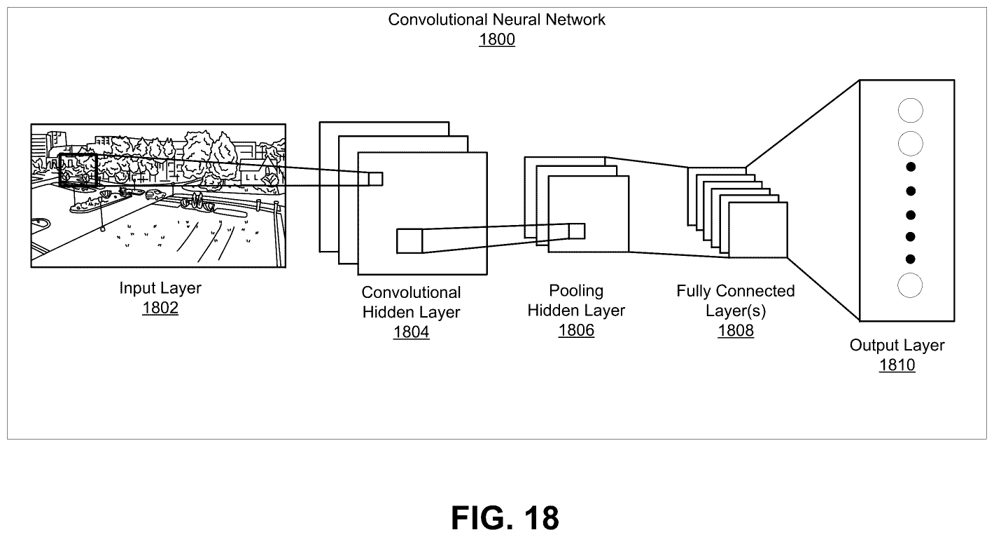

FIG. 18 is an illustrative example of a convolutional neural network (CNN) 1800. The input layer 1802 of the CNN 1800 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1804, an optional non-linear activation layer, a pooling hidden layer 1806, and fully connected layer 1808 (which fully connected layer 1808 can be hidden) to get an output at the output layer 1810. While only one of each hidden layer is shown in FIG. 18, one of ordinary skill will appreciate that multiple convolutional hidden layers, non-linear layers, pooling hidden layers, and/or fully connected layers can be included in the CNN 1800. As previously described, the output can indicate a single class of an object or can include a probability of classes that best describe the object in the image.

The first layer of the CNN 1800 can be the convolutional hidden layer 1804. The convolutional hidden layer 1804 can analyze image data of the input layer 1802. Each node of the convolutional hidden layer 1804 is connected to a region of nodes (pixels) of the input image called a receptive field. The convolutional hidden layer 1804 can be considered as one or more filters (each filter corresponding to a different activation or feature map), with each convolutional iteration of a filter being a node or neuron of the convolutional hidden layer 1804. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1804. Each connection between a node and a receptive field for that node learns a weight and, in some cases, an overall bias such that each node learns to analyze its particular local receptive field in the input image. Each node of the convolutional hidden layer 1804 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1804 is due to each node of the convolutional layer being applied to its corresponding receptive field. For example, a filter of the convolutional hidden layer 1804 can begin in the top-left corner of the input image array and can convolve around the input image. As noted above, each convolutional iteration of the filter can be considered a node or neuron of the convolutional hidden layer 1804. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1804. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1804.

The mapping from the input layer to the convolutional hidden layer 1804 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1804 can include several activation maps in order to identify multiple features in an image. The example shown in FIG. 18 includes three activation maps. Using three activation maps, the convolutional hidden layer 1804 can detect three different kinds of features, with each feature being detectable across the entire image.

In some examples, a non-linear hidden layer can be applied after the convolutional hidden layer 1804. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1800 without affecting the receptive fields of the convolutional hidden layer 1804.

The pooling hidden layer 1806 can be applied after the convolutional hidden layer 1804 (and after the non-linear hidden layer when used). The pooling hidden layer 1806 is used to simplify the information in the output from the convolutional hidden layer 1804. For example, the pooling hidden layer 1806 can take each activation map output from the convolutional hidden layer 1804 and generates a condensed activation map (or feature map) using a pooling function. Max-pooling is one example of a function performed by a pooling hidden layer. Other forms of pooling functions be used by the pooling hidden layer 1806, such as average pooling, L2-norm pooling, or other suitable pooling functions. A pooling function (e.g., a max-pooling filter, an L2-norm filter, or other suitable pooling filter) is applied to each activation map included in the convolutional hidden layer 1804. In the example shown in FIG. 18, three pooling filters are used for the three activation maps in the convolutional hidden layer 1804.

In some examples, max-pooling can be used by applying a max-pooling filter (e.g., having a size of 2×2) with a stride (e.g., equal to a dimension of the filter, such as a stride of 2) to an activation map output from the convolutional hidden layer 1804. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1804 having a dimension of 24×24 nodes, the output from the pooling hidden layer 1806 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1800.

The final layer of connections in the network is a fully-connected layer that connects every node from the pooling hidden layer 1806 to every one of the output nodes in the output layer 1810. Using the example above, the input layer includes 28×28 nodes encoding the pixel intensities of the input image, the convolutional hidden layer 1804 includes 3×24×24 hidden feature nodes based on application of a 5×5 local receptive field (for the filters) to three activation maps, and the pooling hidden layer 1806 includes a layer of 3×12×12 hidden feature nodes based on application of max-pooling filter to 2×2 regions across each of the three feature maps. Extending this example, the output layer 1810 can include ten output nodes. In such an example, every node of the 3×12×12 pooling hidden layer 1806 is connected to every node of the output layer 1810.

The fully connected layer 1808 can obtain the output of the previous pooling hidden layer 1806 (which should represent the activation maps of high-level features) and determines the features that most correlate to a particular class. For example, the fully connected layer 1808 can determine the high-level features that most strongly correlate to a particular class and can include weights (nodes) for the high-level features. A product can be computed between the weights of the fully connected layer 1808 and the pooling hidden layer 1806 to obtain probabilities for the different classes. For example, if the CNN 1800 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1810 can include an M-dimensional vector (in the prior example, M=10). M indicates the number of classes that the CNN 1800 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

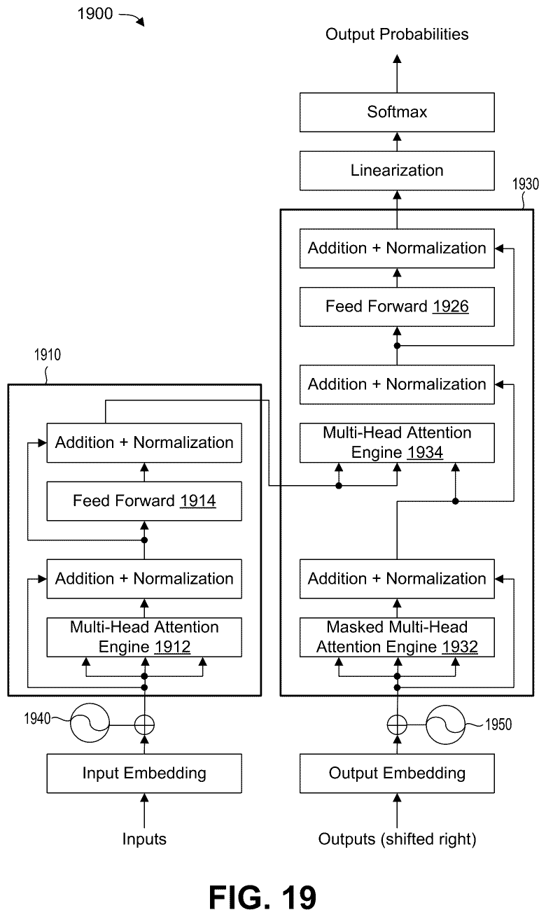

FIG. 19 is a block diagram of an example transformer in accordance with some aspects of the disclosure. In a convolutional neural network (CNN) model, the number of operations required to relate signals from two arbitrary input or output positions grows in the distance between positions, which makes learning dependencies at different distant positions challenging for a CNN model. A transformer 1900 reduces the operations of learning dependencies by using an encoder 1910 and a decoder 1930 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1910 is composed of a stack of six identical layers and each layer has two sub-layers. The first sub-layer is a multi-head self-attention engine 1912, and the second sub-layer is a fully-connected feed-forward network 1914. A residual connection (not shown) connects around each of the sub-layers followed by normalization.

In this example transformer 1900, the decoder 1930 is also composed of a stack of six 6 identical layers. The decoder also includes a masked multi-head self-attention engine 1932, a multi-head attention engine 1934 over the output of the encoder 1910, and a fully-connected feed-forward network 1926. Each layer includes a residual connection (not shown) around the layer, which is followed by layer normalization. The masked multi-head self-attention engine 1932 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 1940 to encode positions because the model does not contain recurrence and convolution and relative or absolute position of the tokens is needed. In the transformer 1900, the positional encodings are added to the input embeddings at the bottom layer of the encoder 1910 and the decoder 1930. The positional encodings are summed with the embeddings because the positional encodings and embeddings have the same dimensions. A corresponding position decoder 1950 is configured to decode the positions of the embeddings for the decoder 1930.

In some aspects, the transformer 1900 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1900 can process input sequences of variable length, making it well-suited for natural language processing tasks where input lengths can vary greatly. Additionally, the self-attention mechanism allows the transformer 1900 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 20 illustrates an example computing-device architecture 2000 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 2000 may include, implement, or be included in any or all of system 500 of FIG. 5, system 600 of FIG. 6, system 700 of FIG. 7 and/or other devices, modules, or systems described herein. Additionally or alternatively, computing-device architecture 2000 may be configured to perform process 1600, and/or other process described herein.

The components of computing-device architecture 2000 are shown in electrical communication with each other using connection 2012, such as a bus. The example computing-device architecture 2000 includes a processing unit (CPU or processor) 2002 and computing device connection 2012 that couples various computing device components including computing device memory 2010, such as read only memory (ROM) 2008 and random-access memory (RAM) 2006, to processor 2002.

Computing-device architecture 2000 can include a cache of high-speed memory connected directly with, in close proximity to, or integrated as part of processor 2002. Computing-device architecture 2000 can copy data from memory 2010 and/or the storage device 2014 to cache 2004 for quick access by processor 2002. In this way, the cache can provide a performance boost that avoids processor 2002 delays while waiting for data. These and other modules can control or be configured to control processor 2002 to perform various actions. Other computing device memory 2010 may be available for use as well. Memory 2010 can include multiple different types of memory with different performance characteristics. Processor 2002 can include any general-purpose processor and a hardware or software service, such as service 1 2016, service 2 2018, and service 3 2020 stored in storage device 2014, configured to control processor 2002 as well as a special-purpose processor where software instructions are incorporated into the processor design. Processor 2002 may be a self-contained system, containing multiple cores or processors, a bus, memory controller, cache, etc. A multi-core processor may be symmetric or asymmetric.

To enable user interaction with the computing-device architecture 2000, input device 2022 can represent any number of input mechanisms, such as a microphone for speech, a touch-sensitive screen for gesture or graphical input, keyboard, mouse, motion input, speech and so forth. Output device 2024 can also be one or more of a number of output mechanisms known to those of skill in the art, such as a display, projector, television, speaker device, etc. In some instances, multimodal computing devices can enable a user to provide multiple types of input to communicate with computing-device architecture 2000. Communication interface 2026 can generally govern and manage the user input and computing device output. There is no restriction on operating on any particular hardware arrangement and therefore the basic features here may easily be substituted for improved hardware or firmware arrangements as they are developed.

Storage device 2014 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 2006, read only memory (ROM) 2008, and hybrids thereof. Storage device 2014 can include services 2016, 2018, and 2020 for controlling processor 2002. Other hardware or software modules are contemplated. Storage device 2014 can be connected to the computing device connection 2012. In one aspect, a hardware module that performs a particular function can include the software component stored in a computer-readable medium in connection with the necessary hardware components, such as processor 2002, connection 2012, output device 2024, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for processing point-cloud data, the apparatus comprising: at least one memory; and at least one processor coupled to the at least one memory and configured to: provide numerical values as input to a diffusion model; provide an input point cloud as a conditioning input to the diffusion model; and process the numerical values using the diffusion model based on the input point cloud to generate an output point cloud, wherein the diffusion model is trained to generate output point clouds based on input point clouds and wherein the output point clouds include more points than are included in the input point clouds.

Aspect 2. The apparatus of aspect 1, wherein the diffusion model is trained using training random values as input and training point clouds as conditioning inputs.

Aspect 3. The apparatus of aspect 2, wherein the training point clouds are generated by a light detection and ranging (LIDAR) system and wherein the input point cloud comprises a point cloud generated by a radio detection and ranging (RADAR) system.

Aspect 4. The apparatus of aspect 3, wherein the training point clouds are downsampled prior to being used to train the diffusion model.

Aspect 5. The apparatus of any one of aspects 1 to 4, wherein the at least one processor is configured to provide time embeddings as keys and values to a cross-attention layer of the diffusion model.

Aspect 6. The apparatus of any one of aspects 1 to 5, wherein the at least one processor is configured to cluster points of the output point cloud.

Aspect 7. The apparatus of aspect 6, wherein the points are clustered based on a spatial distance within the output point cloud.

Aspect 8. The apparatus of any one of aspects 6 or 7, wherein the points are clustered based on entropy.

Aspect 9. The apparatus of any one of aspects 6 to 8, wherein the points are clustered based on another point cloud.

Aspect 10. The apparatus of any one of aspects 1 to 9, wherein the numerical values comprise a tensor of gaussian random values.

Aspect 11. The apparatus of any one of aspects 1 to 10, wherein the numerical values comprise random values.

Aspect 12. The apparatus of aspect 11, wherein the apparatus comprises a computing system of a vehicle.

Aspect 13. The apparatus of aspect 12, wherein the apparatus is configured to adjust an operating parameter of the vehicle based on the output point cloud.

Aspect 14. The apparatus of aspect 13, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the output point cloud using a user interface of the vehicle.

Aspect 15. A method for processing point-cloud data, the method comprising: providing numerical values as input to a diffusion model; providing an input point cloud as a conditioning input to the diffusion model; and processing the numerical values using the diffusion model based on the input point cloud to generate an output point cloud, wherein the diffusion model is trained to generate output point clouds based on input point clouds and wherein the output point clouds include more points than are included in the input point clouds.

Aspect 16. The method of aspect 15, wherein the diffusion model is trained using training random values as input and training point clouds as conditioning inputs.

Aspect 17. The method of aspect 16, wherein the training point clouds are generated by a light detection and ranging (LIDAR) system and wherein the input point cloud comprises a point cloud generated by a radio detection and ranging (RADAR) system.

Aspect 18. The method of aspect 17, wherein the training point clouds are downsampled prior to being used to train the diffusion model.

Aspect 19. The method of any one of aspects 15 to 18, further comprising providing time embeddings as keys and values to a cross-attention layer of the diffusion model.

Aspect 20. The method of any one of aspects 15 to 19, further comprising clustering points of the output point cloud.

Aspect 21. The method of aspect 20, wherein the points are clustered based on a spatial distance within the output point cloud.

Aspect 22. The method of any one of aspects 20 or 21, wherein the points are clustered based on entropy.

Aspect 23. The method of any one of aspects 20 to 22, wherein the points are clustered based on another point cloud.

Aspect 24. The method of any one of aspects 15 to 23, wherein the numerical values comprise a tensor of gaussian random values.

Aspect 25. The method of any one of aspects 15 to 24, wherein the numerical values comprise random values.

Aspect 26. The method of any one of aspects 15 to 25, further comprising adjusting an operating parameter of a vehicle based on the output point cloud.

Aspect 27. The method of aspect 26, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the output point cloud using a user interface of the vehicle.

Aspect 28. A non-transitory computer-readable storage medium having stored thereon instructions that, when executed by at least one processor, cause the at least one processor to perform operations according to any of aspects 15 to 27.

Aspect 29. An apparatus for providing virtual content for display, the apparatus comprising one or more means for perform operations according to any of aspects 15 to 27.

What is claimed is:

1. An apparatus for processing point-cloud data, the apparatus comprising:
at least one memory; and
at least one processor coupled to the at least one memory and configured to:
provide numerical values as input to a diffusion model;
provide an input point cloud as a conditioning input to the diffusion model; and
process the numerical values using the diffusion model based on the input point cloud to generate an output point cloud, wherein the diffusion model is trained to generate output point clouds based on input point clouds and wherein the output point clouds include more points than are included in the input point clouds.

2. The apparatus of claim 1, wherein the diffusion model is trained using training random values as input and training point clouds as conditioning inputs.

3. The apparatus of claim 2, wherein the training point clouds are generated by a light detection and ranging (LIDAR) system and wherein the input point cloud comprises a point cloud generated by a radio detection and ranging (RADAR) system.

4. The apparatus of claim 3, wherein the training point clouds are downsampled prior to being used to train the diffusion model.

5. The apparatus of claim 1, wherein the at least one processor is configured to provide time embeddings as keys and values to a cross-attention layer of the diffusion model.

6. The apparatus of claim 1, wherein the at least one processor is configured to cluster points of the output point cloud.

7. The apparatus of claim 6, wherein the points are clustered based on a spatial distance within the output point cloud.

8. The apparatus of claim 6, wherein the points are clustered based on entropy.

9. The apparatus of claim 6, wherein the points are clustered based on another point cloud.

10. The apparatus of claim 1, wherein the numerical values comprise a tensor of gaussian random values.

11. The apparatus of claim 1, wherein the numerical values comprise random values.

12. The apparatus of claim 11, wherein the apparatus comprises a computing system of a vehicle.

13. The apparatus of claim 12, wherein the apparatus is configured to adjust an operating parameter of the vehicle based on the output point cloud.

14. The apparatus of claim 13, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the output point cloud using a user interface of the vehicle.

15. A method for processing point-cloud data, the method comprising:
providing numerical values as input to a diffusion model;
providing an input point cloud as a conditioning input to the diffusion model; and
processing the numerical values using the diffusion model based on the input point cloud to generate an output point cloud, wherein the diffusion model is trained to generate output point clouds based on input point clouds and wherein the output point clouds include more points than are included in the input point clouds.

16. The method of claim 15, wherein the diffusion model is trained using training random values as input and training point clouds as conditioning inputs.

17. The method of claim 16, wherein the training point clouds are generated by a light detection and ranging (LIDAR) system and wherein the input point cloud comprises a point cloud generated by a radio detection and ranging (RADAR) system.

18. The method of claim 17, wherein the training point clouds are downsampled prior to being used to train the diffusion model.

19. The method of claim 15, further comprising providing time embeddings as keys and values to a cross-attention layer of the diffusion model.

20. The method of claim 15, further comprising adjusting an operating parameter of a vehicle based on the output point cloud, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the output point cloud using a user interface of the vehicle.
